(19) United States
(12) Patent Application Publication
(10) Pub. No.: US 2026/0359091 A1
(43) Pub. Date: Nov. 12, 2026

(54) VIRTUAL MACHINE STARTING METHOD, HOST, CLOUD SERVICE SYSTEM, AND STORAGE MEDIUM

(71) Applicant: CLOUD INTELLIGENCE ASSETS HOLDING (SINGAPORE) PRIVATE LIMITED, Singapore (SG)

(72) Inventors: Xiantao ZHANG, Hangzhou City, Zhejiang Province (CN); Jinkui REN, Shanghai (CN); Wenduo WANG, Hangzhou City, Zhejiang Province (CN); Yun XU, Hangzhou City, Zhejiang Province (CN); Bang DI, Shanghai (CN); Qinghe XU, Shanghai (CN); Shengbo TENG, Hangzhou City, Zhejiang Province (CN)

(73) Assignee: CLOUD INTELLIGENCE ASSETS HOLDING (SINGAPORE) PRIVATE LIMITED, Singapore (SG)

(21) Appl. No.: 19/489,749

(22) PCT Filed: Mar. 7, 2024
(86) PCT No.: PCT/CN2024/080638

§ 371 Date: Dec. 3, 2025

(30) Foreign Application Priority Data
Jun. 12, 2023 (CN) 202310696590.5

(51) Int. Cl. G06F 9/455

(52) U.S. Cl. CPC G06F 9/45558; G06F 2009/45575; G06F 2009/45583

(57) ABSTRACT

Embodiments of the present application provide a virtual machine (VM) starting method, a host, a cloud service system, and a storage medium. The embodiments of the present application provide a memory snapshot-based VM starting scheme, for use in skipping the steps, such as mirror image loading, OS initialization, and service or application initialization, in a conventional VM starting process, thereby improving the VM starting efficiency. Furthermore, in a memory snapshot-based VM starting process, on the basis of page loading sequence record information of a memory snapshot, missing page data in a memory snapshot can be loaded if page missing information is generated during the access of a GPA, thereby loading page data in the memory snapshot while running the page data, rather than loading all page data and then running same, thereby further improving the VM starting efficiency and reducing the VM starting time.

### CROSS REFERENCE TO RELATED APPLICATIONS

This application is a National Stage Entry under 35 U.S.C. § 371 of PCT International Application No. PCT/CN 2024/080638 filed on Mar. 7, 2024, which claims priority to Chinese Patent Application No. CN 202310696590.5, filed with the China National Intellectual Property Administration on Jun. 12, 2023 and entitled “VIRTUAL MACHINE STARTING METHOD, HOST, CLOUD SERVICE SYSTEM, AND STORAGE MEDIUM”, the entire contents of each of which are incorporated herein by reference.

### TECHNICAL FIELD

This application relates to the field of cloud computing technologies, and in particular, to a virtual machine starting method, a host, a cloud service system, and a storage medium.

### BACKGROUND

With the development of cloud computing technology, various virtualization instances, such as virtual machines (Virtual Machines, VMs), have emerged. The conventional VM starting steps are generally as follows: downloading a related mirror image; mirror image loading; operating system (Operating System, OS) initialization; and related service or application initialization.

If a plurality of identical VMs need to be started, all the VMs need to go through mirror image loading, OS initialization, and initialization of related services or applications, resulting in excessively long starting time and affecting user experience.

### SUMMARY

Various aspects of this application provide a virtual machine starting method, a host, a cloud service system, and a storage medium, to shorten starting time of a VM.

An embodiment of this application provides a virtual machine starting method, applied to a virtual machine management program running on a host. The method includes: loading, in response to a virtual machine VM startup instruction, a target memory snapshot required for starting a first VM on the host into a target memory space of the virtual machine management program, and allocating a guest physical address space GPA to the first VM; directly accessing the GPA if page loading sequence record information corresponding to the target memory snapshot is obtained, and loading target page data from the target memory space into the GPA based on the page loading sequence record information when page missing information is generated during the access of the GPA; and executing the target page data in the GPA, to start the first VM, where the target page data is page data in the target memory snapshot that corresponds to the page missing information.

An embodiment of this application further provides a cloud service system, including: a control node and at least one virtual machine management program running on at least one host, where the control node is configured to sense a virtual machine VM startup requirement, and send a VM startup instruction to a target virtual machine management program among the at least one virtual machine management program, for the target virtual machine management program to start a first VM on a host on which the target virtual machine management program is located; the target virtual machine management program is configured to load, in response to a virtual machine VM startup instruction, a target memory snapshot required for starting the first VM into a target memory space of the target virtual machine management program, and allocate a guest physical address space GPA to the first VM; directly access the GPA if page loading sequence record information corresponding to the target memory snapshot is obtained, and loading target page data from the target memory space into the GPA based on the page loading sequence record information when page missing information is generated during the access of the GPA; and execute the target page data in the GPA, to start the first VM, where the target page data is page data in the target memory snapshot that corresponds to the page missing information.

An embodiment of this application further provides a container starting method, applied to a container management program running on a host. The method includes: loading, in response to a container startup instruction, a target memory snapshot required for starting a first container on the host into a target memory space of the container management program, and allocating a guest physical address space GPA to the first container; directly accessing the GPA if page loading sequence record information corresponding to the target memory snapshot is obtained, and loading target page data from the target memory space into the GPA based on the page loading sequence record information when page missing information is generated during the access of the GPA; and executing the target page data in the GPA, to start the first container, where the target page data is page data in the target memory snapshot that corresponds to the page missing information.

An embodiment of this application further provides a host, including: a storage and a processor. The storage stores a virtual machine management program. The processor is coupled to the storage and is configured to execute the virtual machine management program, to implement the steps in the virtual machine starting method provided in the embodiments of this application.

An embodiment of this application further provides a computer-readable storage medium storing a computer program. The computer program is a virtual machine management program. The virtual machine management program, when executed by a processor, causes the processor to implement the steps in the virtual machine starting method provided in the embodiments of this application.

In the embodiments of this application, a memory snapshot-based VM starting scheme is provided to skip steps such as mirror image loading, OS initialization, and service or application initialization in the conventional VM starting process, thereby improving VM starting efficiency. Further, in the memory snapshot-based VM starting process, the page loading sequence record information of the memory snapshot enables loading missing page data in the memory snapshot when the page missing information is generated during the access of the GPA, thereby loading page data in the memory snapshot while executing the page data, rather than loading all page data and then executing the page data, further improving the VM starting efficiency and reducing VM starting time.

### BRIEF DESCRIPTION OF THE DRAWINGS

The accompanying drawings described here are used to provide a further understanding of this application and form a part of this application. The illustrative embodiments of this application and explanations thereof are used to explain this application and do not constitute an improper limitation on this application. In the drawings:

FIG. 1 is a schematic structural diagram of a cloud service system according to an exemplary embodiment of this application;

FIG. 2 is a schematic diagram of a virtual machine starting process according to an exemplary embodiment of this application;

FIG. 3a is a schematic flowchart of a virtual machine starting method according to an exemplary embodiment of this application;

FIG. 3b is a simplified schematic flowchart of a virtual machine starting method according to an embodiment of this application;

FIG. 3c is a schematic flowchart of a container starting method according to an exemplary embodiment of this application;

FIG. 4 is a schematic structural diagram of a virtual machine starting apparatus according to an exemplary embodiment of this application; and

FIG. 5 is a schematic structural diagram of a host of an exemplary embodiment of this application.

### DETAILED DESCRIPTION

To make objectives, technical solutions, and advantages of this application clearer, the technical solutions of this application are clearly and completely described below with reference to particular embodiments and corresponding accompanying drawings of this application. Apparently, the described embodiments are only some but not all of the embodiments of this application. Based on the embodiments of this application, all other embodiments obtained by a person of ordinary skill in the art without making creative efforts fall within the scope of protection of this application.

It should be noted that user information (including, but not limited to, user equipment information, user personal information, and the like) and data (including, but not limited to, data used for analysis, stored data, displayed data, and the like) involved in the embodiments of this application all are information and data authorized by the user or fully authorized by each party, the collection, use, and processing of relevant data need to comply with relevant laws, regulations, and standards of relevant countries and regions, and corresponding operation portals are provided for a user to choose to authorize or refuse.

For the technical problem of excessively long starting time in the conventional VM starting process caused by mirror image loading, OS initialization, and initialization of related services or applications, the embodiments of this application provide a memory snapshot-based VM starting scheme, to skip steps such as mirror image loading, OS initialization, and service or application initialization in the conventional VM starting process, thereby improving VM starting efficiency. Further, in the memory snapshot-based VM starting process, the page loading sequence record information of the memory snapshot enables loading missing page data in the memory snapshot when the page missing information is generated during the access of the GPA, thereby loading page data in the memory snapshot while executing the page data, rather than loading all page data and then executing the page data, further improving the VM starting efficiency and reducing VM starting time.

Technical solutions provided in the embodiments of this application are described in detail below with reference to the accompanying drawings.

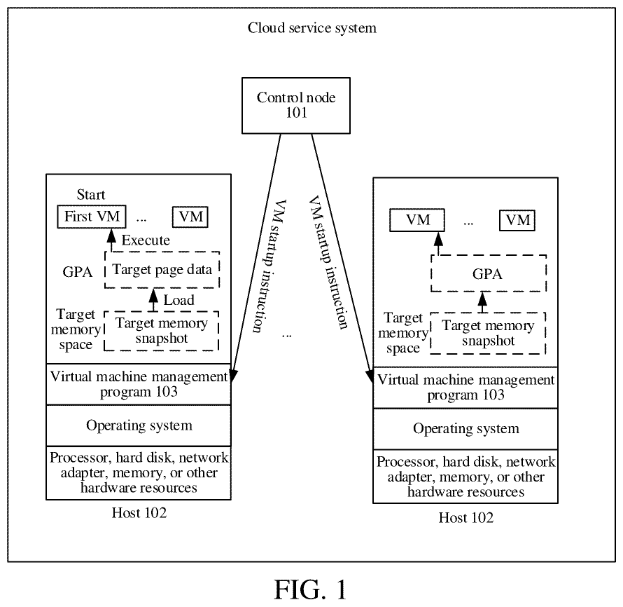

FIG. 1 is a schematic structural diagram of a cloud service system according to an exemplary embodiment of this application. As shown in FIG. 1, the system 100 includes: a control node 101 and at least one virtual machine management program 103 running on at least one host 102.

In this embodiment, the host 102 may be any physical device capable of providing hardware resources, for example, may be a mobile phone, a notebook computer, a storage device, or a conventional server, or may be a cloud device having hardware resources, such as a cloud server or a cloud host. In this embodiment, the host 102 is responsible for providing hardware resources required for VM operation, for example, including but not limited to: a processor (CPU), a storage (such as a memory), a network interface card, a persistent storage, an input/output device, and other devices having specific processing functions, such as an input/output memory management unit (Input/Output Memory Management Unit, IOMMU). The IOMMU may be configured for translation between a virtual machine physical address and a host physical address.

The host 102 not only has hardware resources but also includes an operating system on top of the hardware resources, and a virtual machine management program 103 runs on the operating system. In FIG. 1, one virtual machine management program 103 running on one host is used as an example for illustration. The virtual machine management program 103 is configured to create an isolated operating environment on a host on which the virtual machine management program 103 is located, and start or create, and manage a VM in the isolated operating environment. The virtual machine management program 103 may be any software program, component, or module capable of creating an isolated operating environment on a host on which the virtual machine management program 103 is located, and starting or creating, and managing a VM in the isolated operating environment. This is not limited. Optionally, the virtual machine management program 103 may be implemented as a virtual operating system emulator (Quick EMUlator, QEMU), a hypervisor (Hypervisor), or the like. This is not limited. The Hypervisor is also referred to as a virtual machine monitor (Virtual Machine Monitor, VMM).

On one host 102, the virtual machine management program 103 may create one or more VMs. In this embodiment, VMs are classified into types, and VMs of the same type can be started by using the same memory snapshot. For example, VMs of the same type may be VMs providing the same function or service. VMs of the same type may be deployed on the same host 102 or on different hosts 102. This is not limited.

In this embodiment, the control node 101 is configured to sense a VM startup or creation requirement, select a target virtual machine management program from the at least one virtual machine management program 103, and send a VM startup instruction to the selected target virtual machine management program, so that the target virtual machine management program starts a first VM on a host on which the target virtual machine management program is located. The first VM may be any VM that needs to be started, and the first VM is a VM capable of being started based on a memory snapshot. For example, a VM among VMs of the same type that precedes the first VM (for example, but not limited to, the first VM started for the first time) may be started using a conventional starting manner, and after the starting, a memory snapshot may be created based on a memory status of the VM, so that VMs of the same type that are started after the VM can be started based on the memory snapshot, thereby reducing VM starting time and improving VM starting efficiency. Optionally, the control node is further responsible for performing various management operations on a VM that has been started on at least one host, such as monitoring an operating status of the VM, allocating a service request to the VM, performing various configurations on the VM, and handling the shutdown, migration, or suspension of the VM.

The implementation in which the control node 101 senses the VM startup requirement is not limited. In an optional embodiment, the control node 101 provides a human-computer interaction interface. A user may request the startup of a VM through the human-computer interaction interface, the control node 101. Specifically, the user provides startup requirement information to the control node through the human-computer interaction interface. The startup requirement information includes a type of the VM that needs to be started, resources required for starting the VM, or the like. The resources required for starting the VM may include computing resources such as a CPU or a GPU, network resources such as bandwidth, and storage resources such as hardware. In another optional embodiment, for virtual machines of the same type, the control node may continuously collect statistics on the number of service requests corresponding to the type of virtual machines. When the number of service requests for the type of virtual machines exceeds a service request threshold that the currently running VMs can handle, the control node senses that, in order to improve quality of service, a new VM needs to be started to accommodate more service requests.

The virtual machine management program among the at least one virtual machine management program to which the control node sends the VM startup instruction is not limited, that is, the implementation of determining the target virtual machine management program from the at least one virtual machine management program is not limited. For example, a resource capacity on the host on which the at least one virtual machine management program is located may be obtained, a target host whose resource capacity exceeds a preset resource capacity threshold is determined, a virtual machine management program on the target host is used as a target virtual machine management program, and a VM startup request is sent to the target virtual machine management program, so that the target virtual machine management program starts the first VM on the target host. For another example, a virtual machine management program is randomly selected from the at least one virtual machine management program as a target virtual machine management program, and a VM startup request is sent to the target virtual machine management program, so that the target virtual machine management program starts the first VM on the host on which the target virtual machine management program is located. For another example, network performance of at least one host may be obtained, a target host having better network performance is selected, a virtual machine management program on the target host is used as a target virtual machine management program, and a VM startup request is sent to the target virtual machine management program, so that the target virtual machine management program starts the first VM on the target host.

In this embodiment, the target virtual machine management program corresponds to a target memory space on the host on which the target virtual machine management program is located. The target memory space is allocated by the target virtual machine management program from a memory space of the host, and is configured to store various data required by the target virtual machine management program during operation, for example, including but not limited to, a target memory snapshot required for starting the first VM. The target memory snapshot may be a memory snapshot saved based on memory data of the first VM in a running state during historical operation of the first VM, or the target memory snapshot may be a memory snapshot saved based on memory data of another VM of the same type as the first VM in a running state during historical operation of the another VM. This is not limited. The target memory snapshot is memory status information of a VM at a specific moment. For example, the memory status information may include, but is not limited to, a CPU, a timer (timer), interrupt information, a random access memory (RAM), an external device, and the like. The target virtual machine management program may load, in response to a virtual machine VM startup instruction, a target memory snapshot required for starting the first VM into a target memory space of the target virtual machine management program.

In this embodiment, in a virtualized environment, a physical storage space of the host needs to be simultaneously used by a plurality of VMs. However, the host actually has only one actual physical storage space, and there is also only one starting address 0 for the physical address, which cannot satisfy the requirement that physical addresses of all VMs start from 0. In this case, what the virtual machine management program needs to do is to “trick” a VM, that is, to allocate physical addresses starting from 0 to each VM through memory virtualization, and perform address translation between a VM physical address and a host physical address, to finally access the host physical address.

The physical addresses allocated to each VM may be implemented as a guest physical address space (Guest Physical Address, GPA), which corresponds to a host physical address space (Host Physical Address, HPA). Each VM corresponds to a page table (Page Table). The page table is used for recording a mapping relationship between the GPA and the host physical address (such as HPA). The page table may be implemented as an extended page table (Extended Page Table, EPT) or a nested page table (Nested Page Table, NPT). A hardware CPU of the host includes an IOMMU, and the IOMMU is mainly configured to look up a page table, translate a GPA into an HPA, and complete address mapping. When the VM accesses the GPA, if page data required by the VM is missing in the GPA, page missing information is generated. The page missing information indicates that the page data required by the VM is missing in the GPA.

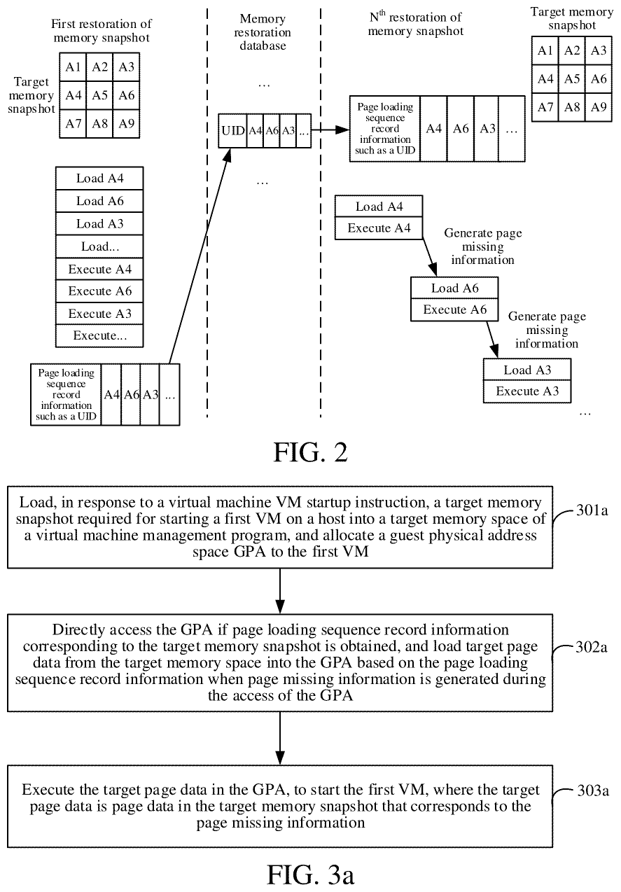

In this embodiment, the target virtual machine management program allocates the GPA to the first VM, and loads the target memory snapshot in the target memory space into the GPA, to execute the page data in the target memory snapshot in the GPA to start the first VM based on the target memory snapshot. In this embodiment, before loading the target memory snapshot in the target memory space into the GPA, the target virtual machine management program may attempt to obtain page loading sequence record information corresponding to the target memory snapshot, for example, obtaining the page loading sequence record information from the VM startup instruction or from a specified database. The target memory snapshot includes a plurality of pieces of page data. The page loading sequence record information represents a loading and execution sequence of page data in the target memory snapshot during the starting of the first VM. The memory snapshot may be represented by an identifier of the memory snapshot (such as a UID). For example, in FIG. 2, the target memory snapshot includes nine pieces of page data, which are respectively A1, A2, A3, . . . , and A9. A loading and execution sequence of the page data during the starting of a corresponding VM is A4->A6->A3->A1->A8->A2->A9->A7->A5. The UID and information about the loading and execution sequence of the page data form the page loading sequence record information.

In this embodiment of this application, whether the target virtual machine management program can obtain the page loading sequence record information corresponding to the target memory snapshot affects an implementation of loading the target memory snapshot in the target memory space into the GPA.

If the page loading sequence record information corresponding to the target memory snapshot is obtained, the target virtual machine management program may directly access the GPA, and during the access of the GPA, based on the generated page missing information, may load the page data in the target memory space while executing the loaded memory page data. Finally, all page data in the target memory snapshot is loaded into the GPA and executed, to start the first VM. Specifically, if during the access of the GPA, page data in the target memory snapshot required for the startup of the first VM is missing in the GPA, page missing information is generated. The missing page data is determined based on the page loading sequence record information. For ease of description, the missing page data is referred to as target page data. Then, the target page data is loaded from the target memory space into the GPA. The target page data is page data in the target memory snapshot that corresponds to the page missing information. Further, when the page missing information is generated, the EPT corresponding to the first VM may be looked up to translate the GPA of the target page data into the HPA of the host. Further, a memory location in the target memory space that corresponds to the HPA is determined, and the target page data is read from the memory location and written into the GPA. As the GPA continues to be accessed and the page missing information is continuously generated, finally, all the page data in the target memory snapshot may be loaded into the GPA and executed, to start the first VM. During the access of the GPA, the page missing information is continuously generated. Correspondingly, the missing page data may be continuously loaded from the target memory space, to load the missing page data while running the loaded page data, rather than loading all the page data into the GPA at once and then executing all the page data as needed, which helps further improve the VM starting efficiency and reducing the VM starting time.

FIG. 2 exemplarily shows a manner of starting the first VM, but is not limited thereto. In FIG. 2, the restoration count of the target memory snapshot is used as an example for illustration. A single restoration of the target memory snapshot indicates that one VM is started. Different restoration processes may be used for starting different VMs, or may correspond to a plurality of startups of the same VM. During the first restoration process of the target memory snapshot, all the page data in the target memory snapshot is loaded at once into the GPA of the corresponding VM, and the page data in the GPA is sequentially executed as loaded, to complete the first restoration process of the target memory snapshot. During the first restoration process, page loading sequence record information corresponding to the target memory snapshot is also formed and stored into a memory restoration database. In this way, During an Nth restoration of (where N>1 and N is a positive integer) of the target memory snapshot, that is, when the VM is started based on the target memory snapshot for an Nth time, the virtual machine management program may obtain the page loading sequence record information corresponding to the target memory snapshot. The page loading sequence record information is illustrated by using A4->A6->A3 . . . as an example. A loading sequence of subsequent page data is not shown in FIG. 2. During the initial access of the GPA, the page missing information may be generated, the page data A4 is determined as the target page data based on the page loading sequence record information, the page data A4 is loaded into the GPA, and the page data A4 in the GPA is executed. Alternatively, before the access of the GPA, the page data A4 is determined as the target page data based on the page loading sequence record information, the page data A4 is loaded into the GPA, and the page data A4 in the GPA is executed. Next, during the execution of the page data A4 in the GPA, the page missing information is generated, the page data A6 is determined as the target page data based on the page loading sequence record information, the page data A6 is loaded into the GPA, and the page data A6 in the GPA is executed. Further, during the execution of the page data A6 in the GPA, the page missing information is generated, the page data A3 is determined as the target page data based on the page loading sequence record information, the page data A3 is loaded into the GPA, and the page data A3 in the GPA is run, until all the page data in the target memory snapshot has been loaded into the GPA and executed. In this case, the first VM is started. In this embodiment, the Nth restoration process of the target memory snapshot is used for starting the first VM. In addition, in this embodiment, for example, the page loading sequence record information is generated during the first restoration process of the target memory snapshot, but is not limited thereto. The page loading sequence record information may be generated during any restoration process before the Nth restoration process.

If the page loading sequence record information is not obtained, which indicates that the page data in the target memory snapshot cannot be sequentially loaded into the GPA based on the page loading sequence record information, and the page data in the GPA cannot be concurrently executed, all the page data in the target memory snapshot may be loaded from the target memory space into the GPA. Then, the GPA is accessed, and the page data in the target memory snapshot in the GPA is executed, to start the first VM.

Further, optionally, the target virtual machine management program may further record a loading sequence of the page data in the target memory snapshot into the GPA, to obtain the page loading sequence record information corresponding to the target memory snapshot. The page loading sequence record information is stored into a memory restoration database, so that the first VM obtains the page loading sequence record information during a subsequent startup process or other VMs of the same type obtains the page loading sequence record information during a startup process. The case in which the page loading sequence record information is not obtained is not limited. For example, the case in which the page loading sequence record information is not obtained may occur when the VM is started by using all the page data in the target memory snapshot for the first time. In this case, a loading sequence of the page data in the target memory snapshot is unknown. Alternatively, the case in which the page loading sequence record information is not obtained may also occur when the VM is not started by using the target memory snapshot for the first time, but a loading sequence of the page data in the target memory snapshot into the GPA is not recorded during a previous VM startup process. In this case, the page loading sequence record information is also unknown.

As shown in FIG. 2, during the first restoration of the memory snapshot, the page data A4, A6, A3, . . . in the target memory space are all loaded into the GPA, and then the GPA is accessed and the loaded page data A4, A6, A3, . . . are executed as needed. During this process, the loaded page data may be tagged to record a loading sequence of the page data, to generate page loading sequence record information A4->A6->A3 . . . , and other page data is not presented. The page loading sequence record information is stored into the memory restoration database, so that the first VM obtains the page loading sequence record information during a subsequent startup process or another VM of the same type obtains the page loading sequence record information during a startup process.

The implementation of storing the page loading sequence record information into the memory restoration database is not limited. For example, the target virtual machine management program sends the page loading sequence record information to the control node, and the control node stores the page loading sequence record information into the memory restoration database. For another example, the control node provides an address of the memory restoration database to the target virtual machine management program, and the target virtual machine management program accesses the address information, and stores the page loading sequence record information into the memory restoration database.

In an optional embodiment, when the target virtual machine management program obtains the page loading sequence record information, the implementation in which the target virtual machine management program obtains the page loading sequence record information is not limited. For example, when sensing a need to start the first VM, in addition to sending the VM startup instruction to the target virtual machine management program and providing related information of the target memory snapshot required for starting the first VM, the control node may further access the memory restoration database to query whether the page loading sequence record information corresponding to the target memory snapshot exists, and when determining that the page loading sequence record information exists, provide the page loading sequence record information or an access address of the page loading sequence record information in the memory restoration database to the target virtual machine management program. Optionally, the control node may add the page loading sequence record information or the access address of the page loading sequence record information in the memory restoration database to the VM startup instruction and provide the VM startup instruction to the target virtual machine management program. The target virtual machine management program may determine whether the VM startup instruction includes the page loading sequence record information; and obtain the page loading sequence record information from the VM startup instruction if the VM startup instruction includes the page loading sequence record information. For another example, the target virtual machine management program may determine whether the VM startup instruction includes the access address information of the page loading sequence record information; and obtain the page loading sequence record information based on the access address information in the VM startup instruction if the VM startup instruction includes the access address information of the page loading sequence record information.

In addition to the above case in which the control node provides the page loading sequence record information corresponding to the target memory snapshot to the target virtual machine management program, the target virtual machine management program may also actively obtain the page loading sequence record information corresponding to the target memory snapshot. For example, after receiving a target startup instruction, the target virtual machine management program may actively initiate an obtaining request to the control node, to request the control node to query the memory restoration database and return the page loading sequence record information corresponding to the target memory snapshot. For another example, after receiving a target startup instruction, the target virtual machine management program may actively initiate an obtaining request to the control node, and may actively query the memory restoration database based on the address information of the memory restoration database and based on the UID of the target memory snapshot, and obtain the page loading sequence record information corresponding to the target memory snapshot.

In the foregoing embodiments of this application, the target memory snapshot is saved during the historical operation of the first VM, or the target memory snapshot is generated during operation of other VMs of the same type as the first VM. Regardless of the foregoing manner of generating the target memory snapshot, the target memory snapshot may be stored as cloud disk data. For example, the target memory snapshot may be stored to a cloud disk by using an elastic block storage (Elastic Block Storage, EBS) technology, to obtain EBS cloud disk data of the target memory snapshot. For ease of distinguishing and description, the cloud disk storing the target memory snapshot is referred to as a first cloud disk.

Based on the above, the target virtual machine management program receives the VM startup instruction sent by the control node. The VM startup instruction includes description information of the target memory snapshot, such as an ID, time, or memory status information of the target memory snapshot, or an identifier or an address of the corresponding cloud disk. The first cloud disk storing the target memory snapshot is mounted to the first VM based on the description information; and the target memory snapshot is obtained from the first cloud disk and stored into the target memory space of the target virtual machine management program. For example, when the description information of the target memory snapshot is the ID, time, or memory status information of the target memory snapshot, the virtual machine management program maintains a correspondence between the description information and a cloud disk loading address. A loading address of the first cloud disk of the target memory snapshot may be determined based on the description information of the target memory snapshot and in combination with the correspondence, an association relationship between the loading address of the first cloud disk and the first VM is established, the target memory snapshot is obtained from the first cloud disk based on the loading address of the first cloud disk, and the target memory snapshot is stored into the target memory space.

In an optional embodiment, during the historical operation of the first VM, all data under a system disk of the first VM may also be saved, to obtain a system disk snapshot. For example, an operating system of the first VM is implemented as a windows system, and the system disk of the first VM corresponds to all data under the C drive of the first VM. Alternatively, during operation, another VM of the same type as the first VM may also store all data under a system disk of the another VM, to obtain a system disk snapshot. Regardless of the foregoing manner of generating the system disk snapshot, the system disk snapshot may be stored as cloud disk data. For example, the system disk snapshot is stored to a cloud disk by using an EBS technology, to obtain EBS cloud disk data of the system disk snapshot. For ease of distinguishing and description, a cloud disk storing the system disk snapshot is referred to as a second cloud disk.

Based on this, the target virtual machine management program may further mount a system disk to the first VM in response to the VM startup instruction. The system disk is configured to provide other data required during operation of the first VM, and is responsible for storing data generated during operation of the first VM. For example, the VM startup instruction may include description information of the system disk snapshot. The description information of the system disk snapshot may be an ID, status information, or save time information of a system. Based on the description information of the system disk snapshot, the system disk snapshot may be obtained from the second cloud disk, and an association relationship between the system disk snapshot and the first VM may be established, to mount the system disk for the first VM.

In an optional embodiment, when a plurality of VMs need to be started on the same host, the memory snapshot can be shared to reduce storage resources occupied for storing memory snapshots, and reduce overall loading time of memory snapshots. Specifically, when the GPA is allocated to the first VM, a shared GPA may be allocated to the first VM, and the page data in the target memory snapshot in the target memory space may be loaded into the shared GPA and executed in a load-before-execute manner or a load-while-execute manner provided in the foregoing embodiments, to start the first VM. The shared GPA is shared by the first VM and another VM of the same type on the host. The first VM and the another VM of the same type on the host have read-only access to the shared GPA, preventing a read operation on the shared GPA from corrupting the data on the shared GPA. The another VM of the same type may also be directly started based on the target memory snapshot in the shared GPA. Specifically, using the first VM is used as an example, after the shared GPA is allocated to the first VM, before the page data in the target memory snapshot in the target memory space is loaded into the shared GPA, whether the page data in the target memory snapshot already exists in the shared GPA may be determined first. If the page data exists, the page data in the shared GPA may be directly executed as needed, and the process of loading the page data from the target memory space into the shared GPA may be omitted, thereby further improving the VM starting efficiency. The case in which the page data in the target memory snapshot already exists in the shared GPA indicates that a VM of the same type has been started based on the shared GPA, and has loaded the page data in the target memory snapshot into the shared GPA in during the startup process of the VM. In this way, a plurality of VMs can share the memory snapshot, thereby reducing storage resources occupied for storing memory snapshots, reducing overall loading time of memory snapshots, and improving the VM starting efficiency.

Further, during operation of the first VM, a private GPA may be further allocated to the first VM, to store page data that is generated during operation of the first VM and that changes relative to the target memory snapshot. That is, the private GPA is used for storing differential memory data. VMs of the same type on the same host are started by using the same memory snapshot in a shared GPA, so that duplicate storage space can be eliminated, and the memory snapshot does not need to be repeatedly loaded into the GPA, thereby reducing loading time of the memory snapshot. The loading time of the memory snapshot can be reduced from time complexity O(N) to time complexity O(1), where N is the number of VMs of the same type sharing the memory snapshot, and N is an integer greater than 1.

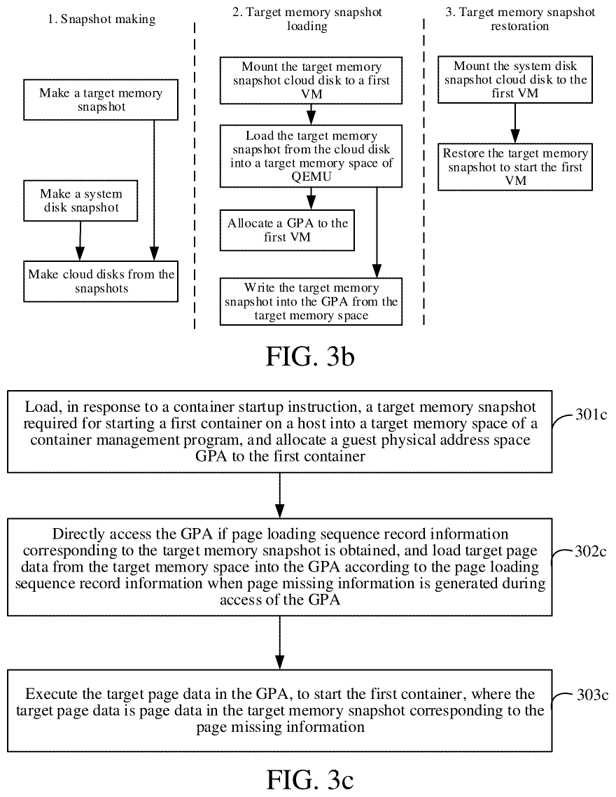

FIG. 3a is a schematic flowchart of a virtual machine starting method according to an exemplary embodiment of this application. The virtual machine starting method is applied to a virtual machine management program running on a host. As shown in FIG. 3a, the method includes the following steps.

301a: Load, in response to a virtual machine VM startup instruction, a target memory snapshot required for starting a first VM on a host into a target memory space of a virtual machine management program, and allocate a guest physical address space GPA to the first VM.

302a: Directly access the GPA if page loading sequence record information corresponding to the target memory snapshot is obtained, and load target page data from the target memory space into the GPA based on the page loading sequence record information when page missing information is generated during the access of the GPA.

303a: Execute the target page data in the GPA, to start the first VM, where the target page data is page data in the target memory snapshot that corresponds to the page missing information.

In an optional embodiment, the method provided in this embodiment of this application further includes: loading all page data in the target memory snapshot from the target memory space into the GPA if the page loading sequence record information is not obtained; and accessing the GPA, and executing the page data in the target memory snapshot in the GPA, to start the first VM.

In an optional embodiment, the method provided in this embodiment of this application further includes: recording a loading sequence of the page data in the target memory snapshot into the GPA, to obtain page loading sequence record information corresponding to the target memory snapshot; and storing the page loading sequence record information into a memory restoration database, for the first VM to obtain the page loading sequence record information during a subsequent startup process or other VMs of the same type to obtain the page loading sequence record information during a startup process.

In an optional embodiment, the method provided in this embodiment of this application further includes: determining whether the VM startup instruction includes the page loading sequence record information or access address information of the page loading sequence record information; and if yes, obtaining the page loading sequence record information from the VM startup instruction, or obtaining the page loading sequence record information based on the access address information in the VM startup instruction, where the page loading sequence record information is generated during a historical startup process of the first VM or during a startup process of other VMs of the same type.

In an optional embodiment, the loading, in response to a virtual machine VM startup instruction, a target memory snapshot required for starting a first VM on the host into a target memory space of the virtual machine management program includes: receiving a VM startup instruction sent by a control node, where the VM startup instruction includes description information of the target memory snapshot; mounting, to the first VM based on the description information, a first cloud disk storing the target memory snapshot; and obtaining the target memory snapshot from the first cloud disk and storing the target memory snapshot into the target memory space.

In an optional embodiment, the allocating a guest physical address space GPA to the first VM includes: allocating a shared GPA to the first VM, where the shared GPA is shared by the first VM and other VMs of the same type on the host; and the method further includes: allocating a private GPA to the first VM during operation of the first VM, to store the page data that is generated by the first VM and that changes relative to the target memory snapshot.

In an optional embodiment, the method provided in this embodiment of this application further includes: mounting a system disk to the first VM in response to the VM startup instruction, where the system disk is configured to provide other data required during operation of the first VM, and is responsible for storing data generated during operation of the first VM.

In an optional embodiment, before loading the target memory snapshot and the system disk, the method further includes: making a target memory snapshot and a system disk snapshot, and making cloud disks from the target memory snapshot and the system disk snapshot. FIG. 3b is a schematic diagram of a process from making cloud disks from a target memory snapshot and a system disk snapshot, to loading the target memory snapshot, and mounting the system disk and restoring the target memory snapshot.

The detailed implementations and beneficial effects of the steps in the method according to this embodiment have been described in detail in the foregoing embodiments. Details are not described herein.

FIG. 3c is a schematic flowchart of a container starting method according to an exemplary embodiment of this application. The method is applied to a container management program running on a host. As shown in FIG. 3c, the method includes the following steps.

301c: Load, in response to a container startup instruction, a target memory snapshot required for starting a first container on the host into a target memory space of a container management program, and allocate a guest physical address space GPA to the first container.

302c: Directly access the GPA if page loading sequence record information corresponding to the target memory snapshot is obtained, and load target page data from the target memory space into the GPA based on the page loading sequence record information when page missing information is generated during the access of the GPA.

303c: Execute the target page data in the GPA, to start the first container, where the target page data is page data in the target memory snapshot that corresponds to the page missing information.

In this embodiment, the container management program may run on a host, and one container management program may run on one host. The container management program is configured to create an isolated operating environment on a host on which the container management program is located, and start or create, and manage a container in the isolated operating environment. The container management program may be any software program, component, or module capable of creating an isolated operating environment on a host on which the container management program is located, and starting or creating, and managing a container in the isolated operating environment. This is not limited. Optionally, the container management program may be implemented as K8s (Kubernetes), Podman, Apptainer, Docker, or the like. Podman is software used for building, managing, and running a container. Kubernetes is an open-source container orchestration platform that enables rapid and efficient deployment, management, and scaling of a containerized application. Apptainer is a container system used in high-performance computing (HPC). Docker is a standard container management technology.

For detailed implementation content and effect descriptions of the foregoing container starting method, refer to the foregoing embodiments. Details are not described herein again.

It should be noted that steps of the methods provided in the foregoing embodiments may be performed by the same device, or the method may be performed by different devices. For example, step 301 to step 303 may be performed by a device A, for another example, steps 301 and step 302 may be performed by a device A, and step 303 may be performed by a device B; and the like.

In addition, some procedures described in the foregoing embodiments and the accompanying drawings include a plurality of operations that appear in a specific sequence. However, it should be clearly understood that the operations may not be performed in the sequence in which the operations appear in this specification or may be performed in parallel. The sequence numbers of the operations, such as 301 and 302, are merely used for distinguishing between different operations, and do not indicate any execution sequence. In addition, the procedures may include more or fewer operations, and the operations may be performed in sequence or in parallel. It should be noted that descriptions such as “first” and “second” in this specification are used for distinguishing between different messages, devices, modules, and the like, and do not indicate any order or limit “first” and “second” to different types.

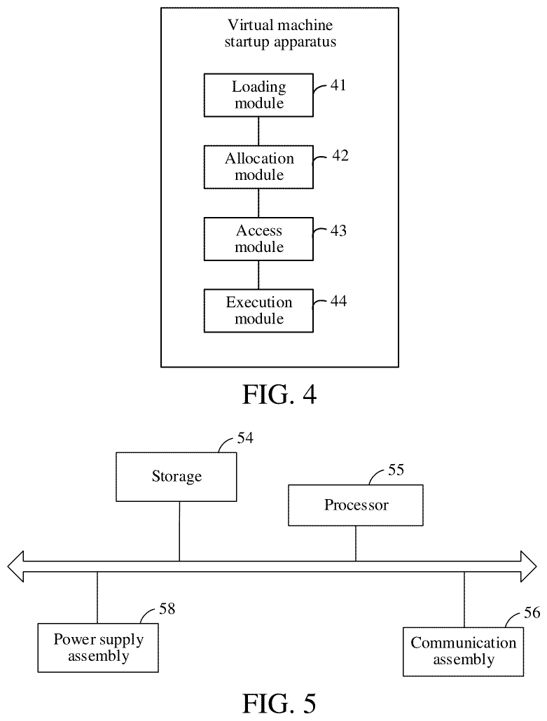

FIG. 4 is a schematic structural diagram of a virtual machine starting apparatus according to an exemplary embodiment of this application. The apparatus is applied to a virtual machine management program running on a host. The apparatus includes: a loading module 41, an allocation module 42, an access module 43, and an execution module 44.

The loading module 41 is configured to load, in response to a virtual machine VM startup instruction, a target memory snapshot required for starting a first VM on a host into a target memory space of a virtual machine management program, and the allocation module 42 allocates a guest physical address space GPA to the first VM.

The access module 43 directly accesses the GPA if page loading sequence record information corresponding to the target memory snapshot is obtained, and the loading module 41 loads target page data from the target memory space into the GPA based on the page loading sequence record information when page missing information is generated during the access of the GPA.

The execution module 44 is configured to execute the target page data in the GPA, to start the first VM, where the target page data is page data in the target memory snapshot that corresponds to the page missing information.

In an optional embodiment, the loading module loads all page data in the target memory snapshot from the target memory space into the GPA if the page loading sequence record information is not obtained; and the access module accesses the GPA, and executes the page data in the target memory snapshot in the GPA, to start the first VM.

In an optional embodiment, the apparatus further includes: a recording module and a storage module. The recording module is configured to record a loading sequence of the page data in the target memory snapshot into the GPA, to obtain page loading sequence record information corresponding to the target memory snapshot. The storage module is configured to store the page loading sequence record information into a memory restoration database, for the first VM to obtain the page loading sequence record information during a subsequent startup process or other VMs of the same type to obtain the page loading sequence record information during a startup process. In an optional embodiment, the apparatus further includes: a determining module and an obtaining module. The determining module is configured to determine whether the VM startup instruction includes the page loading sequence record information or access address information of the page loading sequence record information. If yes, the obtaining module obtains the page loading sequence record information from the VM startup instruction, or obtains the page loading sequence record information based on the access address information in the VM startup instruction. The page loading sequence record information is generated during a historical startup process of the first VM or during a startup process of other VMs of the same type.

In an optional embodiment, the loading module is specifically configured to: receive a VM startup instruction sent by a control node, where the VM startup instruction includes description information of the target memory snapshot; mount, to the first VM based on the description information, a first cloud disk storing the target memory snapshot; and obtain the target memory snapshot from the first cloud disk and store the target memory snapshot into the target memory space.

In an optional embodiment, the apparatus further includes: a mounting module. The mounting module is configured to mount a system disk to the first VM in response to the VM startup instruction, where the system disk is configured to provide other data required during operation of the first VM, and is responsible for storing data generated during operation of the first VM.

In an optional embodiment, the allocation module is specifically configured to: allocate a shared GPA to the first VM, where the shared GPA is shared by the first VM and another VM of the same type on the host; and allocate a private GPA to the first VM during operation of the first VM, to store the page data that is generated by the first VM and that changes relative to the target memory snapshot.

The apparatus shown in FIG. 4 may further be applied to a container management program on a host. Specifically,
the loading module is configured to load, in response to a container startup instruction, a target memory snapshot required for starting a first container on a host into a target memory space of a container management program, and the allocation module allocates a guest physical address space GPA to the first container.

The access module directly accesses the GPA if page loading sequence record information corresponding to the target memory snapshot is obtained, and the loading module loads target page data from the target memory space into the GPA based on the page loading sequence record information when page missing information is generated during the access of the GPA.

The execution module is configured to execute the target page data in the GPA, to start the first container, where the target page data is page data in the target memory snapshot that corresponds to the page missing information.

The detailed implementations and beneficial effects of the virtual machine starting apparatus provided in this embodiment have been described in detail in the foregoing embodiments. Details are not described herein.

FIG. 5 is a schematic structural diagram of a host of an exemplary embodiment of this application. As shown in FIG. 5, the host includes: a storage 54 and a processor 55.

The storage 54 is configured to store a virtual machine management program, and may be configured to store other various data to support operations on the host. Examples of such data include instructions for any application or method executed on the host.

The storage 54 may be implemented by any type of volatile or non-volatile storage devices or a combination thereof, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, a magnetic disk, or an optical disc.

The processor 55 is coupled to the storage 54, and is configured to execute the virtual machine management program in the storage 54, to load, in response to a virtual machine VM startup instruction, a target memory snapshot required for starting the first VM on a host into a target memory space of the virtual machine management program, and allocate a guest physical address space GPA to the first VM; directly access the GPA if page loading sequence record information corresponding to the target memory snapshot is obtained, and load target page data from the target memory space into the GPA based on the page loading sequence record information when page missing information is generated during the access of the GPA; and execute the target page data in the GPA, to start the first VM, where the target page data is page data in the target memory snapshot that corresponds to the page missing information.

In an optional embodiment, the processor 55 is further configured to: load all page data in the target memory snapshot from the target memory space into the GPA if the page loading sequence record information is not obtained; and access the GPA, and execute the page data in the target memory snapshot in the GPA, to start the first VM.

In an optional embodiment, the processor 55 is further configured to: record a loading sequence of the page data in the target memory snapshot into the GPA, to obtain page loading sequence record information corresponding to the target memory snapshot; and store the page loading sequence record information into a memory restoration database, for the first VM to obtain the page loading sequence record information during a subsequent startup process or other VMs of the same type to obtain the page loading sequence record information during a startup process.

In an optional embodiment, the processor 55 is further configured to determine whether the VM startup instruction includes the page loading sequence record information or access address information of the page loading sequence record information; and if yes, obtain the page loading sequence record information from the VM startup instruction, or obtain the page loading sequence record information based on the access address information in the VM startup instruction, where the page loading sequence record information is generated during a historical startup process of the first VM or during a startup process of other VMs of the same type.

In an optional embodiment, when loading, in response to the virtual machine VM startup instruction, the target memory snapshot required for starting the first VM on the host into the target memory space of the virtual machine management program, the processor 55 is specifically configured to: receive a VM startup instruction sent by a control node, where the VM startup instruction includes description information of the target memory snapshot; mount, to the first VM based on the description information, a first cloud disk storing the target memory snapshot; and obtain the target memory snapshot from the first cloud disk and store the target memory snapshot into the target memory space.

In an optional embodiment, the processor 55 is further configured to: mount a system disk to the first VM in response to the VM startup instruction, where the system disk is configured to provide other data required during operation of the first VM, and is responsible for storing data generated during operation of the first VM.

In an optional embodiment, when allocating the guest physical address space GPA to the first VM, the processor 55 is specifically configured to: allocate a shared GPA to the first VM, where the shared GPA is shared by the first VM and other VMs of the same type on the host; and the processor 55 is further configured to: allocate a private GPA to the first VM during operation of the first VM, to store the page data that is generated by the first VM and that changes relative to the target memory snapshot.

Further, as shown in FIG. 5, the host further includes other components such as a communication assembly 56 or a power supply assembly 58. Only some components are schematically shown in FIG. 5, which does not mean that the host includes only the components shown in FIG. 5.

The detailed implementations and beneficial effects of the host provided in this embodiment have been described in detail in the foregoing embodiments. Details are not described herein.

An embodiment of this application further provides a host. An implementation structure of the host is the same as or similar to the implementation structure of the host shown in FIG. 5, and may be implemented with reference to the structure of the host shown in FIG. 5. A difference between the host provided in this embodiment and the host in the embodiment shown in FIG. 5 mainly lies in that the processor executes a container management program stored in the storage. For the host provided in this embodiment, the processor of the host executes the container management program stored in the storage, and may be configured to: load, in response to a container startup instruction, a target memory snapshot required for starting a first container on the host into a target memory space of a container management program, and allocate a guest physical address space GPA to the first container; directly access the GPA if page loading sequence record information corresponding to the target memory snapshot is obtained, and load target page data from the target memory space into the GPA based on the page loading sequence record information when page missing information is generated during the access of the GPA; and execute the target page data in the GPA, to start the first container, where the target page data is page data in the target memory snapshot that corresponds to the page missing information.

The detailed implementations and beneficial effects of the host provided in this embodiment have been described in detail in the foregoing embodiments. Details are not described herein.

Correspondingly, an embodiment of this application further provides a computer-readable storage medium storing a computer program. The computer program, when executed by a processor, is capable of implementing the steps executable by the processor in the method embodiments shown in FIG. 3a and FIG. 3c. The storage may be implemented by any type of volatile or non-volatile storage device or a combination thereof, such as a static random access memory (Static Random-Access Memory, SRAM), an electrically erasable programmable read-only memory (Electrically Erasable Programmable Read Only Memory, EEPROM), an erasable programmable read-only memory (Erasable Programmable Read Only Memory, EPROM), a programmable read-only memory (Programmable Read-Only Memory, PROM), a read-only memory (Read-Only Memory, ROM), a magnetic memory, a flash memory, a magnetic disk, or an optical disc.

The communication assembly is configured to facilitate wired or wireless communication between a device in which the communication assembly is located and another device. The device in which the communication assembly is located may access a wireless network based on communication standards, such as Wi-Fi, and 2G, 3G, 4G/LTE, 5G, and other mobile communication networks, or a combination thereof. In an exemplary embodiment, the communication assembly receives a broadcast signal or broadcast related information from an external broadcast management system through a broadcast channel. In an exemplary embodiment, the communication assembly further includes a near field communication (Near Field Communication, NFC) module, to facilitate short-range communication. For example, the NFC module may be implemented based on a radio frequency identification (Radio Frequency Identification, RFID) technology, an infrared data association (Infrared Data Association, IrDA) technology, an ultra-wideband (Ultra Wide Band, UWB) technology, a Bluetooth (BlueTooth, BT) technology, and other technologies.

A display includes a screen, and the screen may include a liquid crystal display (Liquid Crystal Display, LCD) and a touch panel (TouchPanel, TP). If the screen includes a touch panel, the screen may be implemented as a touchscreen to receive an input signal from the user. The touch panel includes one or more touch sensors to sense touching, sliding, and gestures on the touch panel. The touch sensor may not only sense boundaries of touch or swipe operations, but also detect the duration and pressure related to the touch or swipe operations.

The power supply assembly provides power to various assemblies of a device in which the power supply assembly is located. The power supply assembly may include a power supply management system, one or more power supplies, and other assemblies associated with generating, managing, and allocating power for the device in which the power supply assembly is located.

An audio assembly may be configured to output and/or input an audio signal. For example, the audio assembly includes a microphone (Microphone, MIC). When a device in which the audio assembly is located is in an operating mode, such as a call mode, a recording mode, and a speech recognition mode, the microphone is configured to receive an external audio signal. The received audio signal may be further stored in the storage or sent through the communication assembly. In some embodiments, the audio assembly further includes a speaker, configured to output an audio signal.

A person skilled in the art should understand that the embodiments of this application may be provided as a method, a system, or a computer program product. Therefore, this application may be implemented in a form of a fully hardware-based embodiment, a fully software-based embodiment, or an embodiment combining both software and hardware aspects. Moreover, this application may use a form of a computer program product implemented on one or more computer-readable storage media (including, but not limited to, a disk storage device, a compact disc read-only memory (Compact Disc Read-Only Memory, CD-ROM), an optical memory, or the like) including computer-usable program code.

This application is described with reference to flowcharts and/or block diagrams of the method, the device (system), and the computer program product according to the embodiments of this application. It should be understood that computer program instructions can implement each process and/or block in the flowcharts and/or block diagrams and a combination of processes and/or blocks in the flowcharts and/or block diagrams. The computer program instructions may be provided for a universal computer, a dedicated computer, an embedded processor, or a processor of another programmable data processing device to generate a machine, so that an apparatus configured to implement a function specified in one or more processes in flowcharts and/or one or more blocks in block diagrams through the instructions executed by the computer or the processor of another programmable data processing device.

The computer program instructions may alternatively be stored in a computer-readable storage that can instruct the computer or another programmable data processing device to work in a specific manner, so that the instructions stored in the computer-readable storage generate an artifact that includes an instruction apparatus. The instruction apparatus implements a function specified in one or more processes in the flowcharts and/or one or more blocks in the block diagrams.

The computer program instructions may alternatively be loaded onto a computer or another programmable data processing device, so that a series of operation steps are performed on the computer or the another programmable device to generate computer-implemented processing. Therefore, the instructions executed on the computer or the another programmable device provide steps for implementing a function specified in one or more processes in the flowcharts and/or one or more blocks in the block diagrams.

In a typical configuration, a computing device includes one or more processors (Central Processing Units, CPUs), an input/output interface, a network interface, and a memory.

The memory may include non-persistent storage in a computer-readable medium, a random access memory (Random Access Memory, RAM), and/or non-volatile memory such as a read-only memory (ROM) or a flash RAM (flash RAM). The memory is an example of the computer-readable medium.

The computer-readable medium includes permanent and non-permanent, and removable and non-removable media. Information storage may be implemented by using any method or technology. The information may be computer-readable instructions, a data structure, a module of a program, or other data. Examples of computer storage media include, but are not limited to, a phase-change random access memory (Phase-change Random Access Memory, PRAM), a static random access memory (SRAM), a dynamic random access memory (Dynamic Random Access Memory, DRAM), another type of random access memory (RAM), a read-only memory (ROM), an electrically erasable programmable read-only memory (EEPROM), a flash memory or other memory technology, a compact disc read-only memory (CD-ROM), a digital versatile disc (Digital Video Disc, DVD) or other optical storage, a magnetic cassette, a magnetic disk storage or other magnetic storage devices, or any other non-transmission medium that can be configured to store information that can be accessed by a computing device. As defined herein, the computer-readable medium does not include transitory computer-readable media (transitory media), such as a modulated data signal and a carrier.

It should further be noted that, the terms “include”, “comprise”, or any other variants thereof are intended to cover a non-exclusive inclusion, so that a process, a method, a product, or a device including a series of elements not only includes such elements, but also includes other elements not expressly listed, or further includes elements inherent to such a process, method, product, or device. Without more limitations, an element limited by a statement “include a/an . . . ” does not exclude additional same elements existing in the process, the method, the commodity, or the device including the elements.

The above descriptions are merely the embodiments of this application and are not intended to limit the protection scope of this application. A person skilled in the art can make various changes and variations to this application. Any modifications, equivalent substitutions, and improvements made within the spirit and principle of this application shall fall within the scope of the claims of this application.

1. A virtual machine starting method, applied to a virtual machine management program running on a host, the method comprising:
loading, in response to a virtual machine VM startup instruction, a target memory snapshot required for starting a first VM on the host into a target memory space of the virtual machine management program, and allocating a guest physical address space GPA to the first VM;
directly accessing the GPA if page loading sequence record information corresponding to the target memory snapshot is obtained, and loading target page data from the target memory space into the GPA based on the page loading sequence record information when page missing information is generated during the access of the GPA; and
executing the target page data in the GPA, to start the first VM, wherein the target page data is page data in the target memory snapshot that corresponds to the page missing information.

2. The method according to claim 1, further comprising:
loading all page data in the target memory snapshot from the target memory space into the GPA if the page loading sequence record information is not obtained; and
accessing the GPA, and executing the page data in the target memory snapshot in the GPA, to start the first VM.

3. The method according to claim 2, further comprising:
recording a loading sequence of the page data in the target memory snapshot into the GPA, to obtain page loading sequence record information corresponding to the target memory snapshot; and
storing the page loading sequence record information into a memory restoration database, for the first VM to obtain the page loading sequence record information during a subsequent startup process or other VMs of the same type to obtain the page loading sequence record information during a startup process.

4. The method according to claim 1, further comprising:
determining whether the VM startup instruction comprises the page loading sequence record information or access address information of the page loading sequence record information; and
if the VM start instruction comprises the page loading sequence record information or access address information of the page loading sequence record information, obtaining the page loading sequence record information from the VM startup instruction, or obtaining the page loading sequence record information based on the access address information in the VM startup instruction, wherein
the page loading sequence record information is generated during a historical startup process of the first VM or during a startup process of other VMs of the same type.

5. The method according to claim 1, wherein the loading, in response to a virtual machine VM startup instruction, a target memory snapshot required for starting a first VM on the host into a target memory space of the virtual machine management program comprises:
receiving a VM startup instruction sent by a control node, wherein the VM startup instruction comprises description information of the target memory snapshot;
mounting, to the first VM based on the description information, a first cloud disk storing the target memory snapshot; and
obtaining the target memory snapshot from the first cloud disk and storing the target memory snapshot into the target memory space.

6. The method according to claim 1, further comprising:
mounting a system disk to the first VM in response to the VM startup instruction, wherein the system disk is configured to provide other data required during operation of the first VM, and is responsible for storing data generated during operation of the first VM.

7. The method according to claim 1, wherein the allocating a guest physical address space GPA to the first VM comprises: allocating a shared GPA to the first VM, wherein the shared GPA is shared by the first VM and other VMs of the same type on the host; and
the method further comprises: allocating a private GPA to the first VM during operation of the first VM, to store the page data that is generated by the first VM and that changes relative to the target memory snapshot.

8. A cloud service system, comprising: a control node and at least one virtual machine management program running on at least one host, wherein
the control node is configured to sense a virtual machine VM startup requirement, and send a VM startup instruction to a target virtual machine management program among the at least one virtual machine management program, for the target virtual machine management program to start a first VM on a host on which the target virtual machine management program is located;
the target virtual machine management program is configured to load, in response to a virtual machine VM startup instruction, a target memory snapshot required for starting the first VM into a target memory space of the target virtual machine management program, and allocate a guest physical address space GPA to the first VM; directly access the GPA if page loading sequence record information corresponding to the target memory snapshot is obtained, and load target page data from the target memory space into the GPA based on the page loading sequence record information when page missing information is generated during the access of the GPA;
and execute the target page data in the GPA, to start the first VM, wherein the target page data is page data in the target memory snapshot that corresponds to the page missing information.

9. The system according to claim 8, wherein the control node is further configured to:
obtain the page loading sequence record information corresponding to the target memory snapshot from the memory restoration database or access address information of the page loading sequence record information; and
add the page loading sequence record information or the access address information of the page loading sequence record information to the VM startup instruction, and send the VM startup instruction to the target virtual machine management program, wherein the page loading sequence record information is generated during a historical startup process of the first VM or during a startup process of other VMs of the same type.

10. The system according to claim 8, wherein the target virtual machine management program is further configured to:
load all page data in the target memory snapshot from the target memory space into the GPA if the page loading sequence record information is not obtained; and
access the GPA, and execute the page data in the target memory snapshot in the GPA, to start the first VM.

11. The system according to claim 10, wherein the target virtual machine management program is further configured to:
record a loading sequence of the page data in the target memory snapshot into the GPA, to obtain page loading sequence record information corresponding to the target memory snapshot; and
send the page loading sequence record information to the control node, wherein the control node stores the page loading sequence record information into a memory restoration database, for the first VM to obtain the page loading sequence record information during a subsequent startup process or other VMs of the same type to obtain the page loading sequence record information during a startup process.

12. A container starting method, applied to a container management program running on a host, the method comprising:
loading, in response to a container startup instruction, a target memory snapshot required for starting a first container on the host into a target memory space of the container management program, and allocating a guest physical address space GPA to the first container;
directly accessing the GPA if page loading sequence record information corresponding to the target memory snapshot is obtained, and loading target page data from the target memory space into the GPA based on the page loading sequence record information when page missing information is generated during the access of the GPA; and
executing the target page data in the GPA, to start the first container, wherein the target page data is page data in the target memory snapshot that corresponds to the page missing information.

13. A host, comprising: a storage and a processor, wherein the storage stores a virtual machine management program, the processor is coupled to the storage and is configured to execute the virtual machine management program, to implement the steps in the method according to claim 1.

14. A computer-readable storage medium storing a computer program, wherein the computer program is a virtual machine management program, and the virtual machine management program, when executed by a processor, causes the processor to implement the steps in the method according to claim 1.

15. A host, comprising: a storage and a processor, wherein the storage stores a virtual machine management program, the processor is coupled to the storage and is configured to execute the virtual machine management program, to implement the steps in the method according to claim 12.

16. A computer-readable storage medium storing a computer program, wherein the computer program is a virtual machine management program, and the virtual machine management program, when executed by a processor, causes the processor to implement the steps in the method according to claim 12.
